(19) United States
(12) Patent Application Publication
(10) Pub. No.: US 2011/0169957 A1
(43) Pub. Date: Jul. 14, 2011

(54) Vehicle Image Processing Method

(75) Inventor: Daniel James Bartz, Rochester Hills, MI (US)

(73) Assignee: FORD GLOBAL TECHNOLOGIES, LLC, Dearborn, MI (US)

(21) Appl. No.: 12/687,321

(22) Filed: Jan. 14, 2010

(51) Int. Cl. H04N 7/18; G01S 15/00; G01P 3/36; G01S 13/58

(52) U.S. Cl. 348/149; 367/89; 356/27; 342/104; 348/E07.085

(57) ABSTRACT

A method for processing an image of the exterior of a vehicle includes transmitting successive camera images from a camera to a processor. Optical flow vectors from the multiple camera images are estimated. The optical flow vectors are compared and objects located on the ground are separated from objects located above the ground. Vehicle motion is estimated. Data from the successive camera images is processed to create an estimated three-dimensional (3D) bird's eye view image, and the bird's eye view image is displayed.

### BACKGROUND

The invention relates to a method for processing images of the exterior of a vehicle. In particular, the invention relates to a method for processing images of the exterior of a vehicle and displaying the processed image for viewing by the vehicle operator.

Apparatus for converting a camera image of a vehicle exterior into a bird's eye view image and displaying the bird's eye view image in the vehicle on which the camera is mounted are known. Such bird's eye view images however, can appear warped or distorted. Cameras in known bird's eye view systems are mounted to an exterior of the vehicle, such as near the license plate mount or in a side view mirror. Such cameras are oriented to the ground at an angle, such as about 45 degrees.

Processors in known bird's eye view systems assume facts about the environment viewed by the camera. For example, known processors assume that every object viewed is lying in the ground plane. Consequently, objects that are in, or very close to the ground plane, such as parking space markings or curbs, appear relatively without distortion in the processed bird's eye view image. In contrast, objects or portions of objects that are higher off the ground, such as the upper portion of a parked vehicle or the upper portion of the tires of the parked vehicle, are assumed to be further from the camera than objects closer to the ground. The known processors then attempt to compensate for the assumed distance of the relatively higher objects by adjusting the displayed image to enlarge the portions of objects assumed to be more distant from the camera. The known systems may thereby display a processed bird's eye view image wherein portions appear distorted. Such distortion makes it difficult for the vehicle driver to understand accurately the physical environment surrounding the vehicle.

For example, a representation of a known bird's eye view image is shown at 10 in FIG. 1. The exemplary image 10 includes the vehicle 12 upon which the camera or cameras are mounted, parking space markings 14, a distorted representation of an adjacent vehicle 16, its associated tires 17, and a distorted representation of an object, such as a traffic cone 18.

It is therefore desirable to provide a system that produces an improved bird's eye view image for viewing within a vehicle upon which a camera is mounted.

### SUMMARY

The present application describes various embodiments of a vehicle image processing method. One embodiment of the method for processing an image of the exterior of a vehicle includes transmitting successive camera images from a camera to a processor. Optical flow vectors from the multiple camera images are estimated. The optical flow vectors are compared and objects located on the ground are separated from objects located above the ground. Vehicle motion is estimated. Data from the successive camera images is processed to create an estimated three-dimensional (3D) bird's eye view image, and the bird's eye view image is displayed.

Other advantages of the vehicle image processing method will become apparent to those skilled in the art from the following detailed description, when read in light of the accompanying drawings.

### BRIEF DESCRIPTION OF THE DRAWINGS

FIG. 1 is a plan view of a representative image of a vehicle exterior processed according to a known bird's eye view processing system.

FIG. 2 is a flow diagram of a system for producing a bird's eye view a vehicle according to the invention.

FIG. 3 is a plan view of an image of a vehicle exterior schematically illustrating the estimation of optical flow of objects relative to the vehicle upon which a camera is mounted.

FIG. 4 is a plan view of an image of a vehicle exterior illustrating a corrected image according to the method of the invention.

FIGS. 5A through 5C are schematic representations of the estimated 3D elevation map step of FIG. 2 using one camera.

FIG. 6 is a schematic illustration of a vehicle determining the height of a sensed object.

FIG. 7 is a schematic view of the object sensed in FIG. 6.

### DETAILED DESCRIPTION

As used in the description of the invention and the appended claims, the phrase “three dimensional” or “3D” is defined as the combination of the height, width, and distance from the vehicle of an object sensed or imaged by a vehicle mounted camera used in the method of the invention.

Referring now to the drawings, there is shown generally at 20 in FIG. 2 the steps in an exemplary embodiment of a method for producing a bird's eye view image of a vehicle 40. In a first step 22 of the exemplary method 20, multiple video camera images are transmitted from a camera (schematically illustrated at 42 in FIG. 4) to a processor (schematically illustrated at 44 in FIG. 4) in the vehicle 40 shown in FIGS. 3 and 4. In the illustrated method, the camera 42 captures a series of sequential images and transmits the captured images to the controller. Alternatively, if more than one camera 42 is used, image data from each of the cameras 42 may be combined or fused into a composite image, as indicated at 21 in FIG. 2.

The vehicle 40 is equipped with at least one camera 42. In the illustrated embodiment, four cameras 42 are mounted to the rear, front, and sides, respectively, of the vehicle 40. In the illustrated embodiment, the side mounted cameras 42 are mounted on or within the side mirrors 46 of the vehicle 40. Alternatively, the side mounted cameras 42 may be mounted to any desired portion of the vehicle sides, such as the doors, front and rear quarter panels, or roof panel, such as the portion of the roof panel between the driver and passenger doors. In the illustrated embodiment, the front camera 42 is mounted to the grill and the rear camera 42 is mounted near the license plate mount. The cameras 42 may be mounted to any other desired locations in the front and rear of the vehicle. In another embodiment, the camera 42 may be mounted to the interior rear-view mirror.

The cameras 42 may be any desired digital camera, such as a charge coupled device (CCD) camera. Alternatively, any other type of camera may be used, such as a complementary metal-oxide-semiconductor (CMOS) camera. In the illustrated embodiment, the cameras 42 are CCD video cameras.

The processor 44 may be any type of image-processing unit suitable for carrying out image-processing. One example of a suitable image processor is the IMAPCAR® processor manufactured by NEC. Another example of a suitable image processor is the PowerPC® processor manufactured by Freescale Semiconductor. Alternatively, any image processor or computer that can recognize road markers such as white lines, stationary objects, and moving vehicles and pedestrians in real time may be used. The processor 42 may be located at any desired location in the vehicle. If desired, memory devices may be used with the processor 44. Examples of such memory devices include a hard disc drive, a DVD drive, and semi-conductor memory.

In a second step 24 of the method 20, optical flow vectors, such as illustrated by the vector arrows 54 and 62 in FIG. 3 may be estimated from multiple video camera images.

The processor 44 may be programmed to assume that the largest portion of an image captured by the camera 42 is the ground. Accordingly, the largest area or portion of an image flowing in the same direction relative to the vehicle 40 may be assumed to be the ground. As shown in FIG. 3, the relatively shorter vector arrows 62 represent the portion of the image that will be interpreted as being on the ground 60 or an object in the ground plane. Examples of objects that may be sensed by the camera 42 and interpreted as being on the ground 60 include lane or parking space markings 64 and curbs (not shown). If desired, vehicle speed may be assumed to be approximately equal to the pixel flow rate of the largest area of optical flow.

As shown in FIG. 3 the relatively longer vector arrows 54 represent an object or portion of the image that is flowing faster than the ground 60 relative to the vehicle 40, and therefore interpreted as being closer to the vehicle. In the illustrated embodiment, the height of such objects will be calculated as described below. Examples of objects that may be sensed by the camera 42 and interpreted as being above the ground 60 include other vehicles 56 and objects such as a traffic cone 58, as shown in FIG. 3, and the generic object 70 shown in FIGS. 6 and 7.

In one embodiment of the method, the ground flow rate of the largest area of optical flow may be estimated by identifying a peak value on one or more histograms of the flow rate and/or direction of pixel flow. In one embodiment of the histogram, the x-axis includes the value of the absolute velocity or magnitude of the pixel flow of the various portions of the image and the y-axis includes the frequency each value appears. In another embodiment of the histogram, the x-axis includes the direction of flow of each pixel in the image and the y-axis includes the frequency each pixel flow direction appears.

In a third step 26 of the method 20, objects located on the ground may be distinguished or separated from objects located above the ground, and further separated from objects moving on a trajectory different than the vehicle 40 upon which the video camera 42 is mounted.

In a fourth step 28 of the method 20, vehicle motion may be estimated. Vehicle motion may be estimated by any desired method. One embodiment of a method of estimating vehicle motion is shown in FIG. 3. In FIG. 3, vehicle motion may be estimated from vehicle sensors, such as sensors for detecting yaw, steering wheel movement, and drive wheel speed and using the ground plane in the camera frame of reference. Motion of objects detected by the camera 42 may be compared to the motion of the vehicle 40 upon which the camera 42 is mounted.

If desired, the fourth step 28 of the method 20, may further include measuring vehicle motion, as shown at 30 in FIG. 2. For example, vehicle motion may be measured by measurement devices such as ultrasound sensors, radar, light detection and ranging (LIDAR), and GPS.

In a fifth step 32 of the method 20, a 3D distortion-free bird's eye view image of the vehicle 40 and its immediate surroundings may be created.

An object or portion of the image that is flowing on a trajectory different than the vehicle 40 will be interpreted as being a moving obstacle. Examples of objects that may be sensed by the camera 42 and interpreted as being an obstacle include vehicles or other objects sensed by the camera 42 but moving on a trajectory different than the vehicle 40.

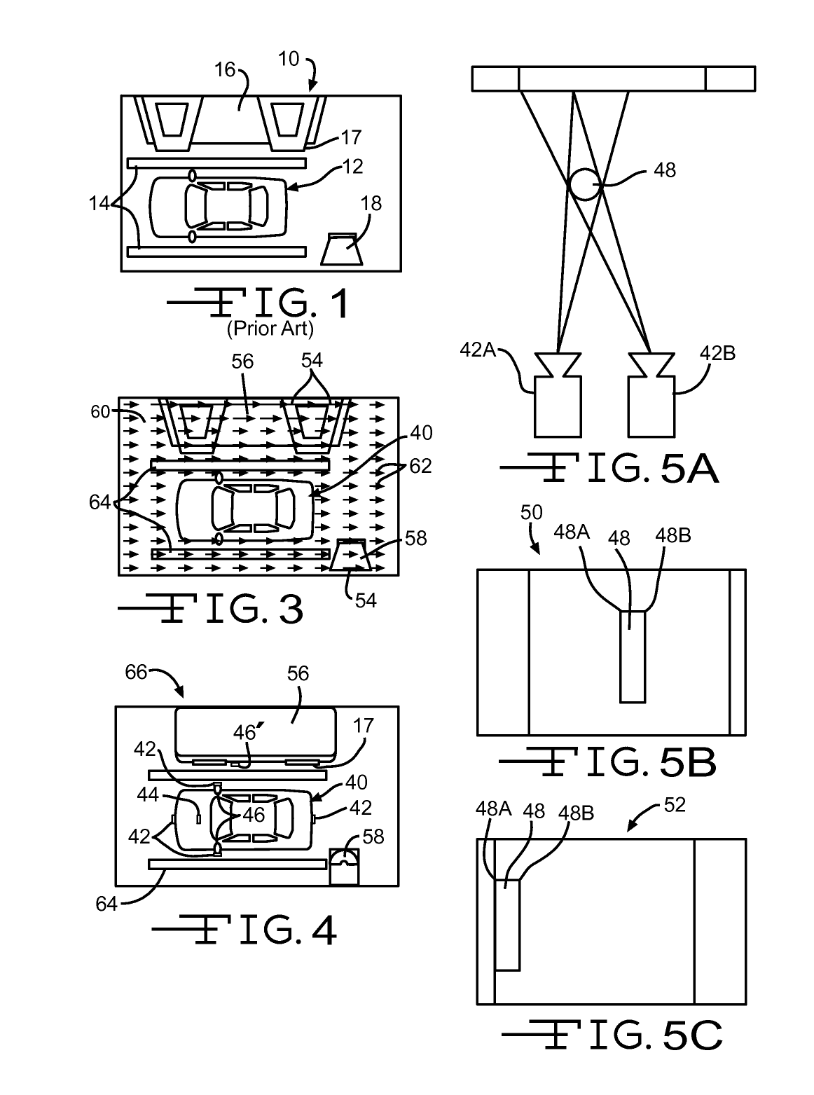

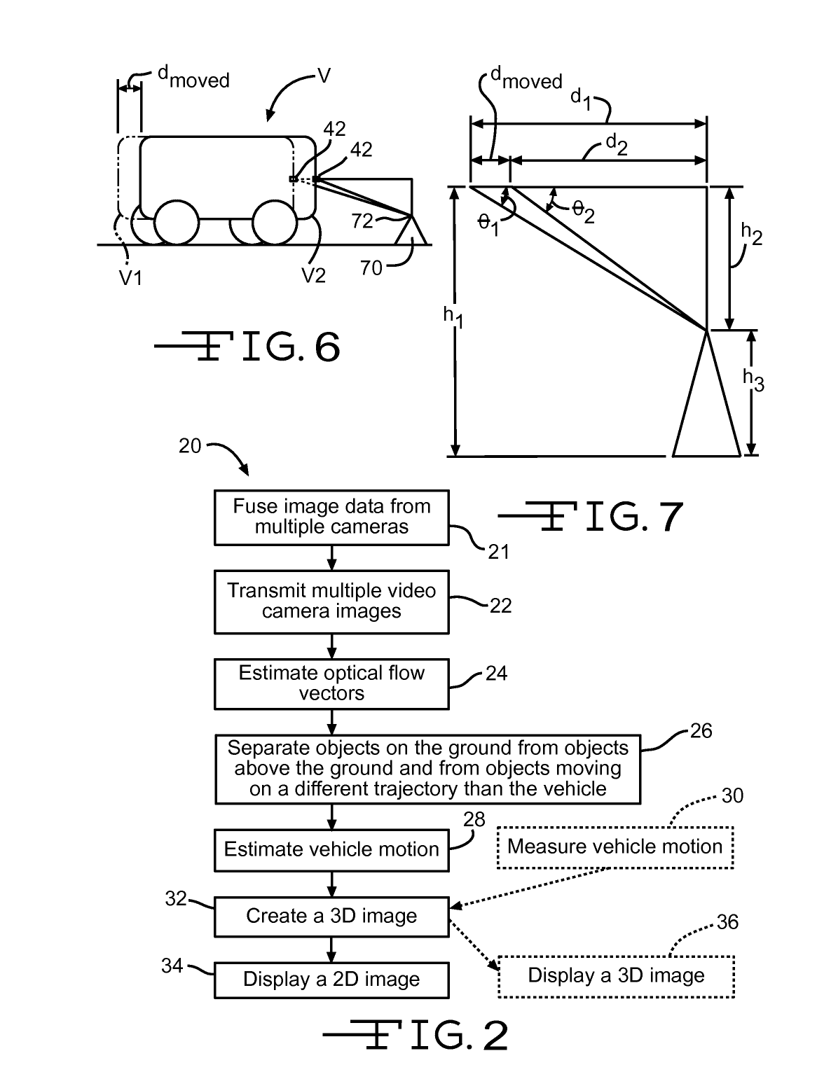

In the exemplary embodiment, a 3D image of the environment outside the vehicle may be estimated using one camera 42, as best shown in FIGS. 5A, 5B, and 5C. For example, as the camera 42 moves, it captures multiple sequential images of nearby objects, such as the object 48. As shown in FIGS. 5A through 5C, the camera 42 captures a first image 50 of the object 48 from a first position 42A and a second image 52 of the object 48 from a second position 42B, as shown in FIGS. 5B and 5C, respectively. The first and second images 50 and 52 may then be processed in the processor 44 to create an estimated 3D image of the environment captured by the camera 48. One or more key features of an imaged object, such as the upper outside corners 48A and 48B of the object 48 may be tracked and analyzed. For example, by comparing the rate of flow of the corner 48A relative to the corner 48B in successive images, an estimate of the object's 48 width and distance from the vehicle may be determined. The object's 48 height may be calculated as described below.

Referring now to FIGS. 6 and 7, one embodiment of a method of calculating the height h₃ of an object 70 is disclosed. As the vehicle V moves from a position V1 to a position V2, the vehicle V moves a known or detected distance d_{moved}, and the camera 42 moves from an angle θ₁ relative to a point 72 on an upper end of an object, represented by the triangle 70, to an angle θ₂ relative to the point y of the object 70.

The height h₃ of the object 70 may then be calculated using the following formulas, wherein:

d_{moved} is the horizontal distance the vehicle V moved between positions V1 and V2.
d₂ is the horizontal distance from the camera 42 in vehicle position V1 and the point y.
d₁ is the sum of d_{moved} and d₂.
θ₁ is the measured angle from the camera in vehicle position V1 to the point y.
θ₂ is the measured angle from the camera in vehicle position V2 to the point y.
h₁ is the known height (vertical distance) of the camera above the ground.
h₂ is the calculated height (vertical distance) from the point y to the camera.
h₃ is the calculated height (vertical distance) of the object 70.

$${d}_{1} = {d}_{moved} + {d}_{2}$$

$${d}_{moved} + \frac{{h}_{2}}{tan {θ}_{2}} = \frac{{h}_{2}}{tan {θ}_{1}}$$

$$tan {θ}_{1} = \frac{{h}_{2}}{{d}_{2}}$$

$${d}_{moved} tan {θ}_{2} tan {θ}_{1} + {h}_{2} tan {θ}_{1} = {h}_{2} tan {θ}_{2}$$

$$tan {θ}_{2} = \frac{{h}_{2}}{{d}_{2}}$$

$${d}_{moved} tan {θ}_{2} tan {θ}_{1} + {h}_{2} ( tan {θ}_{2} - tan {θ}_{1} )$$

$${d}_{moved} + {d}_{2} = \frac{{h}_{2}}{tan {θ}_{1}}$$

$${h}_{2} = \frac{{d}_{moved} tan {θ}_{2} tan {θ}_{1}}{tan {θ}_{2} - tan {θ}_{1}}$$

$${d}_{2} = \frac{{h}_{2}}{tan {θ}_{2}}$$

$${h}_{3} = {h}_{1} - {h}_{2}$$

In a sixth step 34 of the method 20, processed 3D data may be displayed as a two-dimensional (2D) image, such as on an in-vehicle monitor. The in-vehicle monitor may be any desired monitor, such as a liquid crystal display (LCD) mounted in an instrument panel or dash board. One example of a representative corrected bird's eye view image that may be viewed on the monitor is shown at 66 in FIG. 4. Alternatively, the vehicle 40 may include other types of visual display devices with which to display the image 66.

Vehicle tires 17 are shown in the corrected image 66 in FIG. 4. It will be understood however, that the final corrected image may not distinguish the tires 17 from the side of the vehicle 56. In another embodiment, the side mirrors 46′ of the vehicle 56 may be visible in the final corrected image 66.

If desired, the sixth step of the method 20 may further include generating and displaying a 3D version of the image on a 3D capable LCD screen, as shown at 36 in FIG. 2. Such a 3D image would allow the vehicle driver to select an arbitrary view point in the displayed image and move or rotate the displayed image in any desired manner.

The principle and mode of operation of the method and system for processing images of the exterior of a vehicle have been described in its preferred embodiment. However, it should be noted that the method described herein may be practiced otherwise than as specifically illustrated and described without departing from its scope.

What is claimed is:

1. A method for processing an image of the exterior of a vehicle comprising:
transmitting successive camera images from a camera to a processor;
estimating optical flow vectors from the multiple camera images;
comparing the optical flow vectors and separating objects located on the ground from objects located above the ground;
estimating vehicle motion;
processing data from the successive camera images to create an estimated three-dimensional (3D) bird's eye view image; and
displaying the bird's eye view image.

2. The method according to claim 1, wherein the step of transmitting multiple camera images from a camera to a processor includes transmitting images of the environment adjacent to the exterior of the vehicle.

3. The method according to claim 1, wherein the step of transmitting multiple camera images from a camera to a processor includes transmitting images from a video camera.

4. The method according to claim 1, further including measuring vehicle motion.

5. The method according to claim 4, wherein vehicle motion is measured with one of an ultrasound sensors, radar, light detection and ranging (LIDAR) devices, and GPS devices.

6. The method according to claim 1, wherein the bird's eye view image is displayed within the vehicle.

7. The method according to claim 6, wherein the bird's eye view image is displayed in a vehicle instrument panel.

8. The method according to claim 6, wherein the bird's eye view image is displayed within the vehicle as a 3D image.

9. The method according to claim 6, wherein the bird's eye view image is displayed within the vehicle as a 2D image.

10. The method according to claim 1, further including determining a width and a distance from the vehicle of an identified object in the camera images.

11. The method according to claim 10, further including calculating the height of the identified object.

12. The method according to claim 1, further including transmitting successive camera images from more than one camera to a processor, and fusing image data from each of the cameras into a composite image.

13. A method for processing an image of the exterior of a vehicle comprising:
transmitting successive camera images from a camera to a processor;
estimating optical flow vectors from the multiple camera images;
comparing the optical flow vectors and separating objects located on the ground from objects located above the ground;
measuring vehicle motion with one of an ultrasound sensors, radar, light detection and ranging (LIDAR) devices, and GPS devices;
processing data from the successive camera images to create an estimated three-dimensional (3D) bird's eye view image; and
displaying a 3D bird's eye view image.

14. The method according to claim 13, wherein the step of transmitting multiple camera images from a camera to a processor includes transmitting images of the environment adjacent to the exterior of the vehicle.

15. The method according to claim 13, wherein the step of transmitting multiple camera images from a camera to a processor includes transmitting images from a video camera.

16. The method according to claim 13, wherein the bird's eye view image is displayed within the vehicle.

17. The method according to claim 16, wherein the bird's eye view image is displayed within the vehicle as one of a 3D image and a 2D image.

18. The method according to claim 13, further including determining a width and a distance from the vehicle of an identified object in the camera images.

19. The method according to claim 18, further including calculating the height of the identified object.

20. The method according to claim 13, further including transmitting successive camera images from more than one camera to a processor, and fusing image data from each of the cameras into a composite image.
